(19) United States
(12) Patent Application Publication
(10) Pub. No.: US 2026/0146640 A1
(43) Pub. Date: May 28, 2026

(54) FASTENING ASSEMBLY

(71) Applicant: Jentech Precision Industrial Co., LTD., TAOYUAN CITY (TW)

(72) Inventors: Hung-Yi WANG, TAOYUAN CITY (TW); Fang-Wei YANG, TAOYUAN CITY (TW); Po-Yuan SU, TAOYUAN CITY (TW); Chang-Chi YEH, TAOYUAN CITY (TW)

(21) Appl. No.: 19/059,473

(22) Filed: Feb. 21, 2025

(30) Foreign Application Priority Data
Nov. 22, 2024 (TW) 113145175

(51) Int. Cl. F16B 37/08

(52) U.S. Cl. CPC F16B 37/0857; F16B 37/0864

(57) ABSTRACT

A fastening assembly includes a nut structure and a screw. The nut structure includes a nut head and a fastening piece. The nut head has a threaded hole. The fastening piece is arranged with the nut head along an axial line. The fastening piece includes a base ring and a plurality of elastic arms. The elastic arms are disposed on the base ring and arranged around the axial line. The elastic arms respectively and at least partially extend towards the threaded hole. Each of the elastic arms has an inner thread. The screw is configured to first couple with the inner threads and then couple with the threaded hole.

### RELATED APPLICATIONS

This application claims priority to Taiwanese Application Serial Number 113145175, filed Nov. 22, 2024, which is herein incorporated by reference in its entirety.

### BACKGROUND

### Technical Field

The present disclosure relates to fastening assemblies.

### Description of Related Art

Since the living standards have been rising nowadays, the demand for the quality of electronic products has also accordingly increased. Facing to a huge market of electronic products, various manufacturers are working hard to enhance the market competitiveness of their brands.

To be specific, apart from enhancing the functions and performances of electronic products, how to effectively improve the structural quality of electronic products at low cost, is undoubtedly an important issue that various manufacturers highly concern.

### SUMMARY

A technical aspect of the present disclosure is to provide a fastening assembly, which can increase the efficiency of connection and the locking strength.

According to an embodiment of the present disclosure, a fastening assembly includes a nut structure and a screw. The nut structure includes a nut head and a fastening piece. The nut head has a threaded hole. The fastening piece is arranged with the nut head along an axial line. The fastening piece includes a base ring and a plurality of elastic arms. The elastic arms are disposed on the base ring and arranged around the axial line. The elastic arms respectively and at least partially extend towards the threaded hole. Each of the elastic arms has an inner thread. The screw is configured to first couple with the inner threads and then couple with the threaded hole.

In one or more embodiments of the present disclosure, the nut head includes a main body and a wall. The main body has a first side and a second side. The second side is opposite to the first side. The threaded hole is located at the first side. The main body further has a screwdriver hole. The screwdriver hole is located at the second side. The screwdriver hole aligns with the threaded hole along the axial line. The wall is connected with the first side. The wall surrounds the elastic arms and abuts against the base ring.

In one or more embodiments of the present disclosure, the wall is spaced apart from the elastic arms.

In one or more embodiments of the present disclosure, the wall has a first length along the axial line. The elastic arms respectively have a second length relative to an end of the wall away from the main body along the axial line. The first length is larger than the second length.

In one or more embodiments of the present disclosure, the main body is spaced apart from the elastic arms.

In one or more embodiments of the present disclosure, the fastening assembly further includes a restricting sleeve. The restricting sleeve includes a ring portion and a plurality of protruding portions. The ring portion is located between the wall and the elastic arms. The protruding portions are connected with the ring portion and respectively located between adjacent two of the elastic arms. The screw includes a threaded section and a body section. The threaded section has an outer thread. The outer thread is configured to first couple with the inner threads and then couple with the threaded hole. The outer thread has a first outer diameter. The body section is connected with the threaded section along the axial line. The body section has a second outer diameter. The second outer diameter is larger than the first outer diameter. The body section is configured to abut against the protruding portions and push the restricting sleeve to move relative to the elastic arms along the axial line.

In one or more embodiments of the present disclosure, the body section has a supporting surface. The supporting surface has an annular shape and surrounds the threaded section. The supporting surface is configured to abut against the protruding portions and push the restricting sleeve to move relative to the elastic arms along the axial line.

In one or more embodiments of the present disclosure, each of the elastic arms includes a threaded portion and a connecting portion. The connecting portion is connected between the threaded portion and the base ring. A corresponding one of the inner threads is located at the threaded portion. The ring portion is configured to at least partially abut against the threaded portion.

In one or more embodiments of the present disclosure, each of the protruding portions is spaced apart from the axial line by a distance. Twice the distance is larger than the first outer diameter and less than the second outer diameter.

In one or more embodiments of the present disclosure, the elastic arms and the protruding portions are evenly distributed around the axial line respectively.

In one or more embodiments of the present disclosure, the base ring and the elastic arms are an integrally-formed structure.

According to an embodiment of the present disclosure, a fastening assembly includes a nut structure and a screw. The nut structure includes a nut head and a fastening piece. The nut head has a threaded hole and a space. The space is communicated with the threaded hole along a direction. The fastening piece includes a base ring and a plurality of elastic arms. The base ring at least partially abuts against the nut head along the direction. The elastic arms are disposed on the base ring and located in the space. The elastic arms are evenly arranged around an axial line and respectively have an inner thread. The axial line is parallel with the direction. The screw is configured to couple with the threaded hole after passing through the elastic arms along the axial line and coupling with the inner threads.

In one or more embodiments of the present disclosure, the nut head includes a main body and a wall. The main body has a first side and a second side. The second side is opposite to the first side. The threaded hole is located at the first side. The main body further has a screwdriver hole. The screwdriver hole is located at the second side and aligns with the threaded hole along the axial line. The wall is connected with the first side. The wall surrounds the elastic arms and abuts against the base ring.

In one or more embodiments of the present disclosure, the main body and the wall are respectively spaced apart from the elastic arms.

In one or more embodiments of the present disclosure, the wall has a first length along the direction. The elastic arms respectively have a second length relative to an end of the wall away from the main body along the direction. The first length is larger than the second length.

In one or more embodiments of the present disclosure, the fastening assembly further includes a restricting sleeve. The restricting sleeve includes a ring portion and a plurality of protruding portions. The ring portion has an annular shape and is located between the wall and the elastic arms. The protruding portions are connected with an inner side of the ring portion and respectively located between adjacent two of the elastic arms. The screw includes a threaded section and a body section. The threaded section has an outer thread. The outer thread is configured to first couple with the inner threads and then couple with the threaded hole. The outer thread has a first outer diameter. The body section is connected with the threaded section along the axial line. The body section has a second outer diameter. The second outer diameter is larger than the first outer diameter. The body section is configured to abut against the protruding portions and push the restricting sleeve to move relative to the elastic arms along the direction towards the main body.

In one or more embodiments of the present disclosure, the body section has a supporting surface. The supporting surface has an annular shape and surrounds the threaded section. The supporting surface is configured to abut against the protruding portions and push the restricting sleeve to move relative to the elastic arms along the direction towards the main body.

In one or more embodiments of the present disclosure, each of the elastic arms includes a threaded portion and a connecting portion. The connecting portion is connected between the threaded portion and the base ring. A corresponding one of the inner threads is located at the threaded portion. The ring portion is configured to at least partially abut against the threaded portion.

In one or more embodiments of the present disclosure, each of the protruding portions is spaced apart from the axial line by a distance. Twice the distance is larger than the first outer diameter and less than the second outer diameter.

In one or more embodiments of the present disclosure, the base ring and the elastic arms are an integrally-formed structure.

The above-mentioned embodiments of the present disclosure have at least the following advantages:
(1) During the assembly between the nut structure and the screw, the threaded section of the screw firstly at least partially squeezes between the elastic arms and presses against the threaded portion of each of the elastic arms, such that each of the elastic arms is at least partially pushed away slightly in an elastic manner, and the outer thread of the threaded section couples with the inner thread of each of the elastic arms. Through this simple coupling mechanism, a preliminary connection between the nut structure and the screw can be quickly formed. Moreover, since the outer thread of the threaded section couples with the inner thread of each of the elastic arms, the nut structure is unlikely to be loosened from the screw. Thus, the efficiency to connect the nut structure to the screw is effectively increased.
(2) After the threaded hole of the main body is tightly coupled with the threaded section of the screw, the body section of the screw also pushes the restricting sleeve along the axial line to a level corresponding to the threaded portion, and the ring portion of the restricting sleeve at least partially abuts against a side of the threaded portion of each of the elastic arms away from the inner thread, such that the inner threads of the elastic arms tightly abut against the outer thread of the threaded section, which facilitates to enhance the locking strength between the nut structure and the screw.

### BRIEF DESCRIPTION OF THE DRAWINGS

The disclosure can be more fully understood by reading the following detailed description of the embodiments, with reference made to the accompanying drawings as follows:

FIG. 1 is a schematic view of a fastening assembly according to an embodiment of the present disclosure, in which the screw is omitted;

FIG. 2 is a sectional view along a sectional line A-A of FIG. 1;

FIG. 3 is a schematic view of the fastening assembly of FIG. 1, in which the nut head is omitted; and

FIGS. 4-7 are sectional views of the application process of the fastening assembly of FIG. 1.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

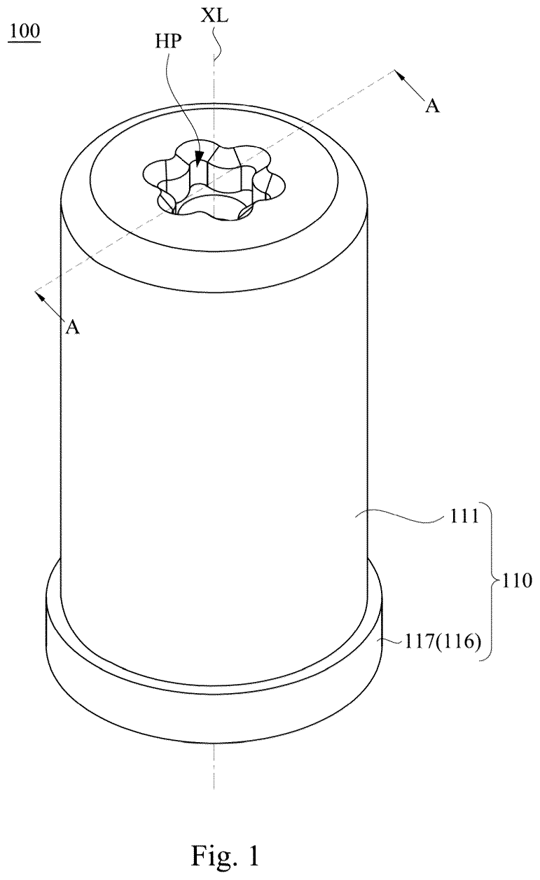

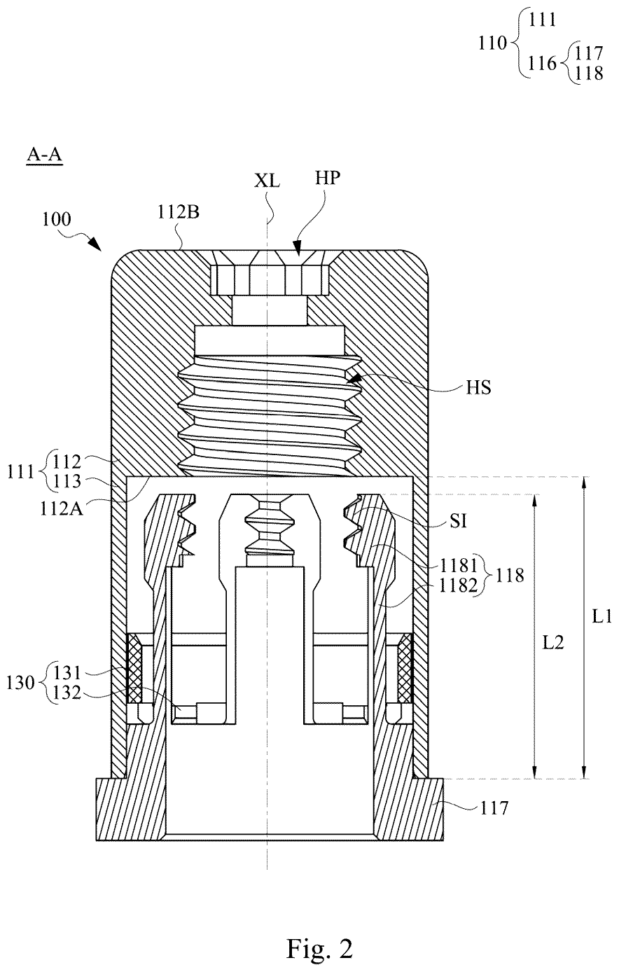

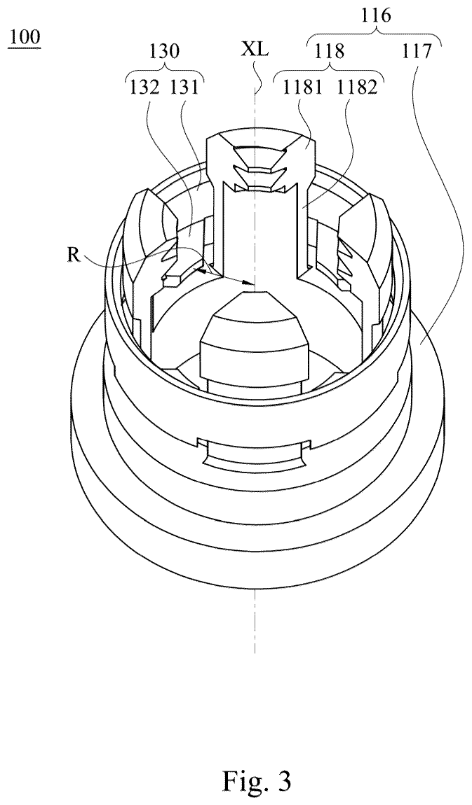

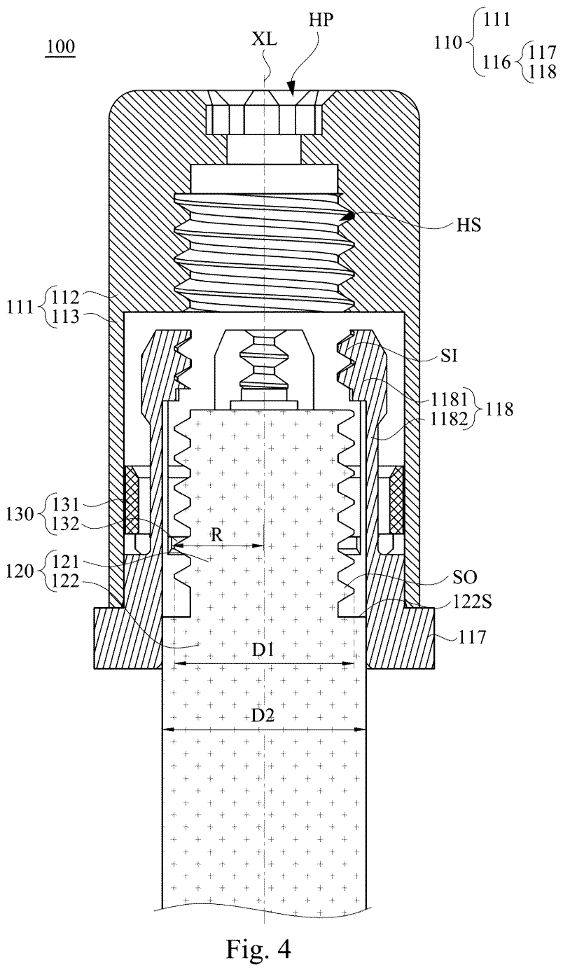

Reference is made to FIGS. 1-3. FIG. 1 is a schematic view of a fastening assembly 100 according to an embodiment of the present disclosure, in which the screw 120 is omitted. FIG. 2 is a sectional view along a sectional line A-A of FIG. 1. FIG. 3 is a schematic view of the fastening assembly 100 of FIG. 1, in which the nut head 111 is omitted. In this embodiment, as shown in FIGS. 1-3, a fastening assembly 100 includes a nut structure 110, a restricting sleeve 130 and a screw 120 (for the sake of drawing clarity, the screw 120 is not shown in FIGS. 1-3, and please refer to FIGS. 4-7 for the screw 120). The nut structure 110 includes a nut head 111 and a fastening piece 116. The nut head 111 has a threaded hole HS. The fastening piece 116 is arranged with the nut head 111 along an axial line XL. The fastening piece 116 includes a base ring 117 and a plurality of elastic arms 118. The elastic arms 118 are disposed on the base ring 117 and arranged around the axial line XL. The elastic arms 118 respectively and at least partially extend towards the threaded hole HS of the nut head 111. Each of the elastic arms 118 has an inner thread SI. In practical applications, the base ring 117 and the elastic arms 118 are an integrally-formed structure, which means the fastening piece 116 is formed from a single piece of material.

To be more specific, as shown in FIG. 2, the nut head 111 includes a main body 112 and a wall 113. The main body 112 has a first side 112A and a second side 112B. The second side 112B is opposite to the first side 112A. The threaded hole HS is located at the first side 112A of the main body 112. The main body 112 further has a screwdriver hole HP. The screwdriver hole HP is located at the second side 112B of the main body 112. The screwdriver hole HP aligns with the threaded hole HS along the axial line XL. The screwdriver hole HP is configured to allow a screwdriver (not shown) to insert into in order to rotate the nut head 111. The wall 113 is connected with the first side 112A of the main body 112. The wall 113 surrounds the elastic arms 118 of the fastening piece 116 and abuts against the base ring 117.

Moreover, as shown in FIG. 2, the wall 113 of the nut head 111 has a first length L1 along the axial line XL, while the elastic arms 118 of the fastening piece 116 respectively have a second length L2 relative to an end of the wall 113 away from the main body 112 along the axial line XL. In this embodiment, the first length L1 of the wall 113 is larger than the second length L2 of each of the elastic arms 118. In other words, the main body 112 of the nut head 111 is spaced apart from the elastic arms 118 of the fastening piece 116. Furthermore, the wall 113 of the nut head 111 is also spaced apart from the elastic arms 118 of the fastening piece 116. Therefore, the elastic arms 118 of the fastening piece 116 and the nut head 111 are free from contact with each other, and the nut head 111 will not hinder the elastic deformation of the elastic arms 118 relative to the base ring 117.

In addition, as shown in FIGS. 2-3, each of the elastic arms 118 includes a threaded portion 1181 and a connecting portion 1182. The connecting portion 1182 is connected between the threaded portion 1181 and the base ring 117, which means the threaded portion 1181 is away from the base ring 117 relative to the connecting portion 1182. A corresponding one of the inner threads SI is located at a side of the threaded portion 1181 facing to the axial line XL.

On the other hand, as shown in FIGS. 2-3, the restricting sleeve 130 includes a ring portion 131 and a plurality of protruding portions 132. The ring portion 131 is located between the wall 113 of the nut head 111 and the elastic arms 118 of the fastening piece 116. The ring portion 131 is configured to at least partially abut against a side of each of the threaded portions 1181 away from the inner thread SI. The protruding portions 132 are connected with the ring portion 131 and respectively located between adjacent two of the elastic arms 118. Each of the protruding portions 132 is spaced apart from the axial line XL by a distance R. In practical applications, the elastic arms 118 of the fastening piece 116 and the protruding portions 132 of the restricting sleeve 130 are evenly distributed around the axial line XL respectively.

Reference is made to FIGS. 4-7. FIGS. 4-7 are sectional views of the application process of the fastening assembly 100 of FIG. 1. In this embodiment, as mentioned above, the fastening assembly 100 further includes the screw 120. As shown in FIGS. 4-7, the screw 120 includes a threaded section 121 and a body section 122. The body section 122 is connected with the threaded section 121 along the axial line XL. The threaded section 121 has an outer thread SO. The outer thread SO has a first outer diameter D1. Moreover, the body section 122 has a second outer diameter D2. In this embodiment, the second outer diameter D2 of the body section 122 is larger than the first outer diameter D1 of the threaded section 121, such that the body section 122 has a supporting surface 122S. The supporting surface 122S has an annular shape and surrounds the threaded section 121.

To be specific, as shown in FIG. 4, the nut structure 110 is moved towards the screw 120, while the screw 120 partially enters into the fastening piece 116 but is not yet coupled with the inner thread SI of each of the elastic arms 118. In this embodiment, twice the distance R between each of the protruding portions 132 of the restricting sleeve 130 and the axial line XL is larger than the first outer diameter D1 of the threaded section 121. Thus, the threaded section 121 of the screw 120 can penetrate through the restricting sleeve 130.

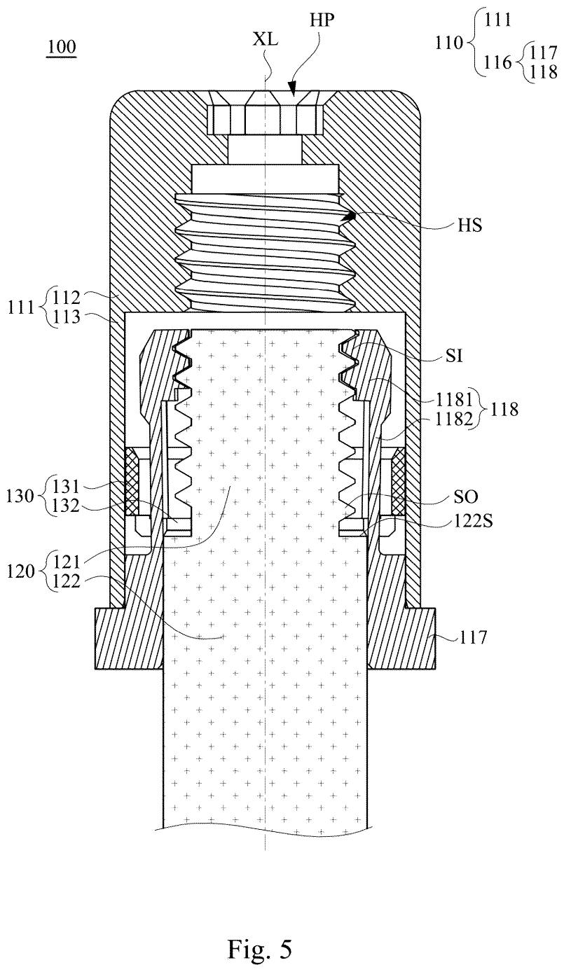

Afterwards, as shown in FIG. 5, the nut structure 110 continues to be moved towards the screw 120, and the threaded section 121 of the screw 120 at least partially squeezes between the elastic arms 118 and presses against the threaded portion 1181 of each of the elastic arms 118, such that each of the elastic arms 118 is at least partially pushed away slightly in an elastic manner, and the outer thread SO of the threaded section 121 couples with the inner thread SI of each of the elastic arms 118. Through this simple coupling mechanism, a preliminary connection between the nut structure 110 and the screw 120 can be quickly formed. Moreover, since the outer thread SO of the threaded section 121 couples with the inner thread SI of each of the elastic arms 118, the nut structure 110 is unlikely to be loosened from the screw 120. Thus, the efficiency to connect the nut structure 110 to the screw 120 is effectively increased.

Furthermore, in this embodiment, twice the distance R between each of the protruding portions 132 of the restricting sleeve 130 and the axial line XL is less than the second outer diameter D2 of the body section 122. Thus, the body section 122 of the screw 120 cannot penetrate through the restricting sleeve 130, and the supporting surface 122S of the body section 122 can abut against the protruding portions 132 of the restricting sleeve 130 and push the restricting sleeve 130 to move relative to the fastening piece 116 along the axial line XL.

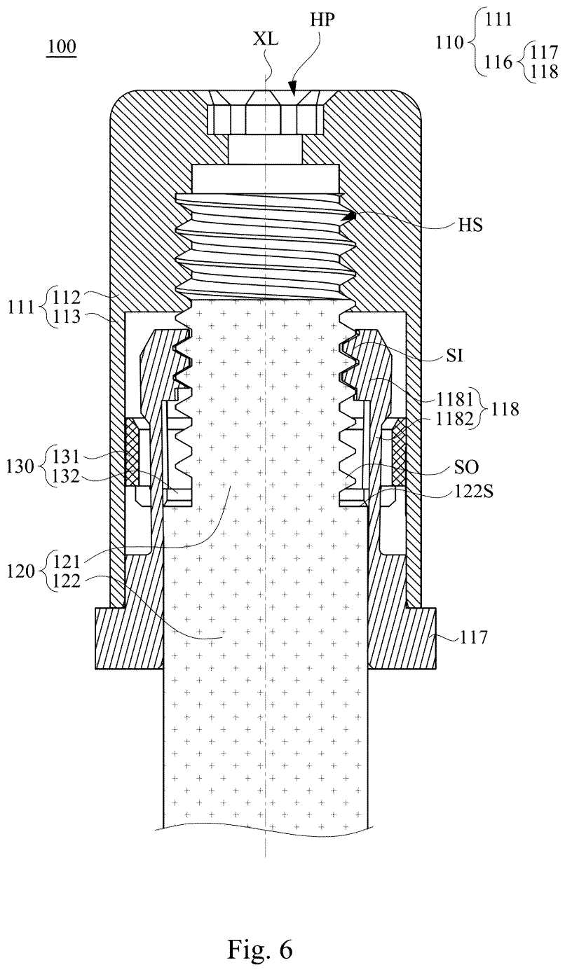

Afterwards, as shown in FIG. 6, the nut structure 110 continues to be moved towards the screw 120, until the outer thread SO of the threaded section 121 is at least partially located in the threaded hole HS of the main body 112. At this point, a user can insert a screwdriver into the screwdriver hole HP of the main body 112 and rotate the nut head 111 relative to the screw 120, such that the outer thread SO of the threaded section 121 is further coupled with the threaded hole HS of the main body 112. In other words, the outer thread SO of the screw 120 is configured to first couple with the inner thread SI of each of the elastic arms 118 and then couple with the threaded hole HS of the main body 112.

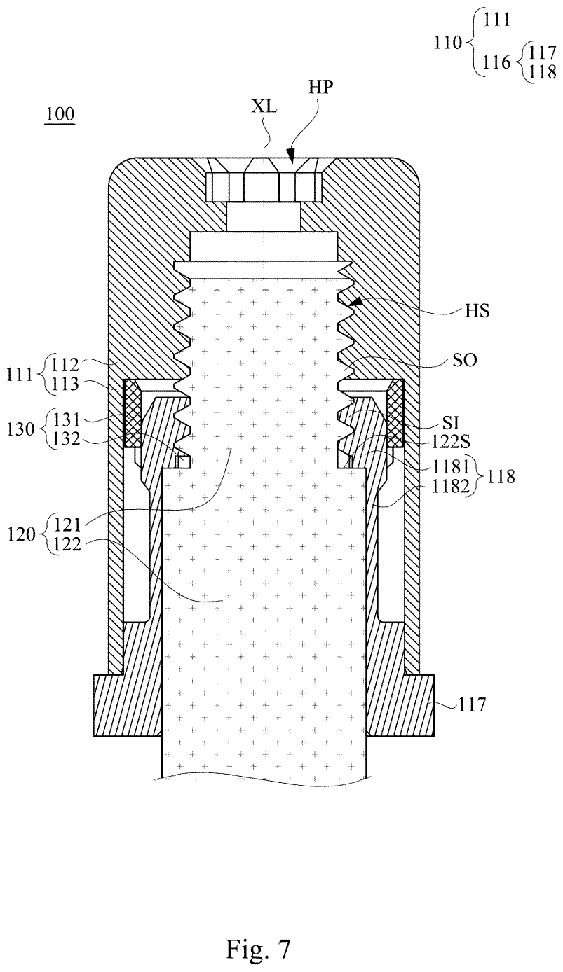

Eventually, as shown in FIG. 7, after the threaded hole HS of the main body 112 is tightly coupled with the threaded section 121 of the screw 120, the body section 122 of the screw 120 also pushes the restricting sleeve 130 along the axial line XL to a level corresponding to the threaded portion 1181, and the ring portion 131 of the restricting sleeve 130 at least partially abuts against a side of the threaded portion 1181 of each of the elastic arms 118 away from the inner thread SI, such that the inner threads SI of the elastic arms 118 tightly abut against the outer thread SO of the threaded section 121, which facilitates to enhance the locking strength between the nut structure 110 and the screw 120.

In conclusion, the aforementioned embodiments of the present disclosure have at least the following advantages:
(1) During the assembly between the nut structure and the screw, the threaded section of the screw firstly at least partially squeezes between the elastic arms and presses against the threaded portion of each of the elastic arms, such that each of the elastic arms is at least partially pushed away slightly in an elastic manner, and the outer thread of the threaded section couples with the inner thread of each of the elastic arms. Through this simple coupling mechanism, a preliminary connection between the nut structure and the screw can be quickly formed. Moreover, since the outer thread of the threaded section couples with the inner thread of each of the elastic arms, the nut structure is unlikely to be loosened from the screw. Thus, the efficiency to connect the nut structure to the screw is effectively increased.
(2) After the threaded hole of the main body is tightly coupled with the threaded section of the screw, the body section of the screw also pushes the restricting sleeve along the axial line to a level corresponding to the threaded portion, and the ring portion of the restricting sleeve at least partially abuts against a side of the threaded portion of each of the elastic arms away from the inner thread, such that the inner threads of the elastic arms tightly abut against the outer thread of the threaded section, which facilitates to enhance the locking strength between the nut structure and the screw.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A fastening assembly, comprising:
a nut structure comprising:
a nut head having a threaded hole; and
a fastening piece arranged with the nut head along an axial line, the fastening piece comprising:
a base ring; and
a plurality of elastic arms disposed on the base ring and arranged around the axial line, the elastic arms respectively and at least partially extending towards the threaded hole, each of the elastic arms has an inner thread; and
a screw configured to first couple with the inner threads and then couple with the threaded hole.

2. The fastening assembly of claim 1, wherein the nut head comprises:
a main body having a first side and a second side opposite to the first side, the threaded hole is located at the first side, the main body further has a screwdriver hole located at the second side and aligning with the threaded hole along the axial line; and
a wall connected with the first side, the wall surrounding the elastic arms and abutting against the base ring.

3. The fastening assembly of claim 2, wherein the wall is spaced apart from the elastic arms.

4. The fastening assembly of claim 2, wherein the wall has a first length along the axial line, the elastic arms respectively have a second length relative to an end of the wall away from the main body along the axial line, the first length is larger than the second length.

5. The fastening assembly of claim 2, wherein the main body is spaced apart from the elastic arms.

6. The fastening assembly of claim 2, further comprising:
a restricting sleeve comprising:
a ring portion located between the wall and the elastic arms; and
a plurality of protruding portions connected with the ring portion and respectively located between adjacent two of the elastic arms,
the screw comprising:
a threaded section having an outer thread configured to first couple with the inner threads and then couple with the threaded hole, the outer thread having a first outer diameter; and
a body section connected with the threaded section along the axial line, the body section having a second outer diameter larger than the first outer diameter, the body section being configured to abut against the protruding portions and push the restricting sleeve to move relative to the elastic arms along the axial line.

7. The fastening assembly of claim 6, wherein the body section has a supporting surface, the supporting surface has an annular shape and surrounds the threaded section, the supporting surface is configured to abut against the protruding portions and push the restricting sleeve to move relative to the elastic arms along the axial line.

8. The fastening assembly of claim 6, wherein each of the elastic arms comprises a threaded portion and a connecting portion, the connecting portion is connected between the threaded portion and the base ring, a corresponding one of the inner threads is located at the threaded portion, the ring portion is configured to at least partially abut against the threaded portion.

9. The fastening assembly of claim 6, wherein each of the protruding portions is spaced apart from the axial line by a distance, twice the distance is larger than the first outer diameter and less than the second outer diameter.

10. The fastening assembly of claim 6, wherein the elastic arms and the protruding portions are evenly distributed around the axial line respectively.

11. The fastening assembly of claim 1, wherein the base ring and the elastic arms are an integrally-formed structure.

12. A fastening assembly, comprising:
a nut structure comprising:
a nut head having a threaded hole and a space communicated with the threaded hole along a direction; and
a fastening piece, comprising:
a base ring at least partially abutting against the nut head along the direction; and
a plurality of elastic arms disposed on the base ring and located in the space, the elastic arms being evenly arranged around an axial line and respectively having an inner thread, the axial line being parallel with the direction; and
a screw configured to couple with the threaded hole after passing through the elastic arms along the axial line and coupling with the inner threads.

13. The fastening assembly of claim 12, wherein the nut head comprises:
a main body having a first side and a second side opposite to the first side, the threaded hole is located at the first side, the main body further has a screwdriver hole located at the second side and aligning with the threaded hole along the axial line; and
a wall connected with the first side, the wall surrounding the elastic arms and abutting against the base ring.

14. The fastening assembly of claim 13, wherein the main body and the wall are respectively spaced apart from the elastic arms.

15. The fastening assembly of claim 13, wherein the wall has a first length along the direction, the elastic arms respectively have a second length relative to an end of the wall away from the main body along the direction, the first length is larger than the second length.

16. The fastening assembly of claim 13, further comprising:
a restricting sleeve comprising:
a ring portion having an annular shape and located between the wall and the elastic arms; and
a plurality of protruding portions connected with an inner side of the ring portion and respectively located between adjacent two of the elastic arms,
the screw comprising:
a threaded section having an outer thread configured to first couple with the inner threads and then couple with the threaded hole, the outer thread having a first outer diameter; and
a body section connected with the threaded section along the axial line, the body section having a second outer diameter larger than the first outer diameter, the body section being configured to abut against the protruding portions and push the restricting sleeve to move relative to the elastic arms along the direction towards the main body.

17. The fastening assembly of claim 16, wherein the body section has a supporting surface, the supporting surface has an annular shape and surrounds the threaded section, the supporting surface is configured to abut against the protruding portions and push the restricting sleeve to move relative to the elastic arms along the direction towards the main body.

18. The fastening assembly of claim 16, wherein each of the elastic arms comprises a threaded portion and a connecting portion, the connecting portion is connected between the threaded portion and the base ring, a corresponding one of the inner threads is located at the threaded portion, the ring portion is configured to at least partially abut against the threaded portion.

19. The fastening assembly of claim 16, wherein each of the protruding portions is spaced apart from the axial line by a distance, twice the distance is larger than the first outer diameter and less than the second outer diameter.

20. The fastening assembly of claim 12, wherein the base ring and the elastic arms are an integrally-formed structure.
